(19) United States
(12) Patent Application Publication
(10) Pub. No.: US 2022/0236630 A1
(43) Pub. Date: Jul. 28, 2022

(54) LIGHT SOURCE DEVICE, PROJECTOR AND LIGHT INTENSITY DISTRIBUTION UNIFORMIZATION METHOD

(71) Applicant: Sharp NEC Display Solutions, Ltd., Tokyo (JP)

(72) Inventors: Hiromi KATAYAMA, Tokyo (JP); Shinichiro CHIKAHISA, Tokyo (JP)

(21) Appl. No.: 17/611,450

(22) PCT Filed: Jul. 12, 2019
(86) PCT No.: PCT/JP2019/027639

§ 371 Date: Nov. 15, 2021

(51) Int. Cl. G03B 21/14; G03B 21/20; G02B 3/00

(52) U.S. Cl. CPC G03B 21/147; G02B 3/0006; G03B 21/2033

(57) ABSTRACT

A light source device for generating laser light that is incident on a microlens array comprising a plurality of microlenses arranged in two directions orthogonal to each other includes a plurality of light sources that emits laser light. The light source image of the light source on the irradiated surface of the microlens array is elliptical, the long axis direction of the light source image intersects with both the two directions.

### TECHNICAL FIELD

The present invention relates to a light source device, a projector including the light source device and a light intensity distribution uniformization method for uniformizing the intensity distribution of light irradiated from the light source device to a specific irradiated surface.

### BACKGROUND OF THE INVENTION

In a projector for projecting a color image, a system is known in which white light emitted from a light source is separated into three primary colors of red, green and blue using a dichroic mirror or a color wheel that rotates at a high speed, and a color image is formed by optical modulating according to a video signal for each separated color light. Liquid crystal panels or DMDs (Digital Micromirror Device) are used for image forming devices used for optical modulating.

In the above-described projector, conventionally, a configuration in which a high brightness discharge lamp or the like is used as a light source is mainly used. However, in recent years, in order to extend product life and low power consumption of a light source, a projector using a semiconductor device such as a laser diode (hereinafter, referred to as LD) or an LED (Light Emitting Diode) as the light source has been developed.

When a semiconductor device is used as a light source, usually because the semiconductor device can only emit a single wavelength light, there is a configuration in which the color light emitted from the light source irradiates to a phosphor as excitation light and the colored lights not directly obtained from the light source are emitted by the phosphor, respectively. For example, when a blue LD that emits laser light having a peak wavelength in a blue wavelength region is used as a light source, red light and green light are emitted by using the phosphors. In some projectors, there is a configuration in which individual phosphors that emit red and right are not used but a phosphor that emits yellow light including red and green components is used. The yellow light, or the red light and the green light emitted by the phosphors are synthesized with the blue light emitted from, for example, the blue LD to convert into white light which is used as illumination light for irradiating the image forming device.

In the configuration using the LD in the light source described above, in order to output a higher brightness light from the light source, it is sufficient to increase the light output (optical power) by increasing the number of LDs. In general, the laser light emitted from the LD is a shape extending in an elliptical cone shape, a cross section perpendicular to the optical axis becomes an elliptical shape having a narrow width in the short axis direction. For example, when a plurality of LDs arranged in a lattice pattern is used, a plurality of light source images formed by each laser light is shown in FIG. 10.

When light from a light source having such a non-uniformity intensity distribution is used, for example, as excitation light for irradiating a phosphor, the luminous efficiency of the phosphor is lowered. Generally, it is known that the luminous efficiency of a phosphor depends on the temperature, and the luminous efficiency decreases when the temperature is high. Therefore, when excitation light having a peak local to the intensity distribution of light is irradiated to the phosphor, the temperature rises at the portion irradiated with the peak light, and light having a low intensity is irradiated at the other portion, so that the luminous efficiency of the phosphor is lowered.

Furthermore, when illumination light including light from a light source having a non-uniform intensity distribution is irradiated to the image forming device, it causes color unevenness and luminance unevenness in the projected image.

Therefore, in a projector using LD as a light source, it is necessary to convert the light from the light source having a non-uniform intensity distribution into light having a uniform intensity distribution at a specific irradiated surface.

As a method of making uniform the light intensity distribution in the irradiated surface, a method of using a diffusion plate, a method of using a rod integrator or a light tunnel, a method of using a microlens array or the like is known. For example, Patent Document 1 describes a configuration in which the intensity distribution of illumination light irradiated from a light source having an LD to an image forming device is made uniform by using a microlens array.

### RELATED ART DOCUMENTS

### Patent Documents

Patent Document 1: JP 2016-062038 A

### SUMMARY

### Problem to be Solved by the Invention

The microlens array is a configuration which comprises a plurality of microlenses (hereinafter, referred to as cells) arranged in two directions orthogonal to each other. As shown in FIG. 11A, on the irradiated surface of the microlens array, if the cells that have sufficiently small with respect to the size of each light source image formed by the laser light are formed, it is possible to increase the uniformity of the light illumination intensity distribution in the irradiated surface as shown in FIG. 11B. However, when the cells are small, edge sagging occurs at the time of manufacture, and the ratio of the ridge line portions formed between the cells increases with the increase in the number of cells. Since the light passing through such the ridge line portions are not subjected to a lens effect, the light utilization efficiency is lowered in the microlens array having the small cells. That is, there is a limit in the manufacturing in the miniaturization of the cells of the microlens array.

As described above, the light source image of the laser light emitted from the LD is elliptical having a narrow width in the short axis direction. When a microlens array having large cells at a certain level with respect to the size of the light source image is used as shown in FIG. 12A, the uniformity of the intensity distribution of light caused by the shape of the light source image in the irradiated surface is reduced as shown in FIG. 12B. This becomes more pronounced as the cells become larger for the size of the light source image on the irradiated surface of the microlens array.

Patent Document 1, when the coherent laser light is incident on the microlens array, the interference fringes are formed on the microlens array, points out a problem in which the interference fringes are superimposed on the same position on the image forming device to become an interference fringe pattern, and proposes a configuration for reducing the occurrence of the interference fringe pattern. The art described in Patent Document 1 does not improve the non-uniformity of the light intensity distribution on the irradiated surface caused by the shape of the light source image.

The present invention has been made to solve the problems of the background art as described above, it is an object of the present invention to provide a light source device, a projector and a light intensity distribution uniformization method that can improve the non-uniformity of the light intensity distribution in a particular irradiated surface caused by the shape of the light source image.

### Means for Solving the Problems

In order to achieve the above object, the light source device of an exemplary aspect of the present invention is a light source device for generating laser light that is irradiated to a microlens array, comprising a plurality of microlenses arranged in two directions orthogonal to each other, comprising:

a plurality of light sources that emits laser light, wherein:

the light source image of the light source on the irradiated surface of the microlens array is elliptical; and

the long axis direction of the light source image intersects with both the two directions.

The projector of an exemplary aspect of the present invention is a projector comprising:

the above light source device;

an optical modulating unit that forms an image light by optical modulating the light emitted from the light source device according to a video signal; and

a projection optical system that projects an image light formed by the optical modulating unit.

An exemplary aspect of the light intensity distribution uniformization method of the present invention is a light intensity distribution uniformization method for uniformizing the intensity distribution of light that is irradiated a specific irradiated surface from a light source device that comprises a plurality of microlenses arranged in two directions orthogonal to each other, for generating laser light that is irradiated a microlens array,

wherein light source device comprises a plurality of light sources that emits laser light,

wherein the light source image of the light source on the irradiated surface of the microlens array is elliptical, the light intensity distribution uniformization method comprising the steps of:

arranging the light source so that the long axis direction of the light source image intersects with both the two directions; and

irradiating the specific irradiated surface with the light emitted from the microlens array.

According to the present invention, it is possible to improve the non-uniformity of the light intensity distribution on a specific irradiated surface caused by the shape of the light source image.

### BRIEF DESCRIPTION OF THE DRAWINGS

FIG. 1 is a schematic diagram showing an example of a configuration of a light source device included in a projector.

FIG. 2 is a schematic view showing an example of a configuration of an illumination projection optical system shown in FIG. 1.

FIG. 3A is a schematic diagram showing an example of the relationship between the light source image and the microlens array of the first exemplary embodiment.

FIG. 3B is a schematic diagram showing an example of the light intensity distribution of the irradiated surface in the relationship between the light source image and the microlens array shown in FIG. 3A.

FIG. 4A is a schematic diagram showing another relationship example of the light source image and the microlens array of the first exemplary embodiment.

FIG. 4B is a schematic diagram showing an example of the light intensity distribution of the irradiated surface in the relationship between the light source image and the microlens array shown in FIG. 4A.

FIG. 5 is a graph showing an example of the peak intensity of light in the irradiated surface with respect to the rotation angle of the light source image.

FIG. 6A is a schematic diagram showing an example of a definition of the size of the light source image.

FIG. 6B is a schematic diagram showing an example of a definition of the size of the cell included in microlens array.

FIG. 7 is a schematic diagram showing another configuration example of a light source device included in the projector.

FIG. 8 is a schematic diagram showing an arrangement example of a light source image obtained by the light source device shown in FIG. 7.

FIG. 9A is a schematic diagram showing an example of the relationship between the light source image and the microlens array of the third exemplary embodiment.

FIG. 9B is a schematic diagram showing an example of the light intensity distribution of the irradiated surface in the relationship between the light source image and the microlens array shown in FIG. 9A.

FIG. 10 is a schematic diagram showing an example of a light source image formed by a laser light.

FIG. 11A is a schematic diagram showing an example of the relationship between the light source image and the microlens array of the background art.

FIG. 11B is a schematic diagram showing an example of the light intensity distribution of the irradiated surface in the relationship between the light source image and the microlens array shown in FIG. 11A.

FIG. 12A is a schematic diagram showing another example of the relationship between the light source image and the microlens array of the background art.

FIG. 12B is a schematic diagram showing an example of the light intensity distribution of the irradiated surface in the relationship between the light source image and the microlens array shown in FIG. 12A.

### EXEMPLARY EMBODIMENT

Next, the present invention will be described with reference to the accompanying drawings.

### First Exemplary Embodiment

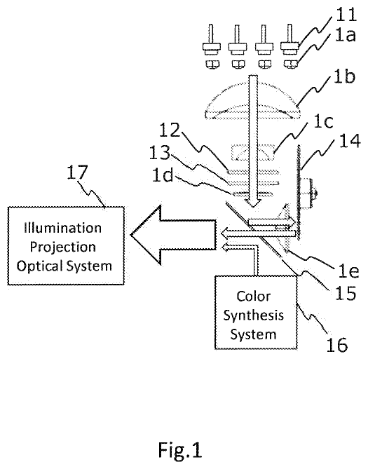

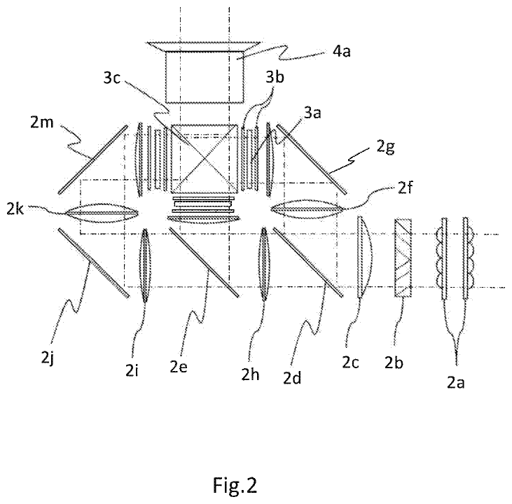

FIG. 1 is a schematic diagram showing an example of a configuration of a light source device included in a projector, FIG. 2 is a schematic diagram showing an example of a configuration of an illumination projection optical system shown in FIG. 1.

FIGS. 1 and 2 illustrate an example of an optical system included in a projector, and the number of lenses, mirrors and the like is not limited to the number shown in FIGS. 1 and 2, may be increased or decreased as necessary. FIG. 1 shows a configuration example of irradiating a laser light emitted from the LD to a ring-shaped phosphor fixed on the phosphor wheel rotating at a high speed as excitation light. The phosphor is not limited to a configuration in which it is fixed on the phosphor wheel, and may be fixed to a predetermined portion that does not have a rotation mechanism or a movement mechanism.

The light source device shown in FIG. 1 includes a plurality of LDs 11, a plurality of collimator lenses 1a, lenses 1b, 1c, 1d and 1e, two sets of microlens arrays 12 and 13, phosphor wheel 14, dichroic mirror 15, and a color synthesis system 16. Although four light sources (LD 11) are shown in FIG. 1, any number of LDs 11 may be used as long as the number is one or more. The plurality of light sources includes a case where the laser light emitted from the LD is divided into a plurality of light sources.

The laser lights emitted from a plurality of LDs 11 are converted into parallel luminous flux, respectively by the collimator lens 1a, the converted lights are condensed by lens 1b and 1c, and are incident on microlens array 12 and 13. Light emitted from microlens array 13 is condensed by the lens 1d and is incident on dichroic mirror 15.

Microlens array 12 which is the incident side divides the light flux of the incident light, microlens array 13 which is the emitting side forms an image each divided light flux on the irradiated surface, microlens arrays 12 and 13 thereby convert the intensity distribution the incident light into uniform light at a predetermined irradiated surface.

Microlens arrays 12 and 13 are configured to include a plurality of cells arranged in two directions orthogonal to each other. Each of the plurality of cells has a square shape or a rectangular shape, and is arranged in a lattice pattern or a staggered shape, for example. The lens included in each cell is a plano-convex lens or a biconvex lens, the lens shape may be square, rectangular or circular. If each cell is formed by a plano-convex lens, the convex surface may be the incident surface side of the light or may be the emitting surface side of the light. When providing the convex surface to the incident surface side and the emitting surface side of the light, respectively, two microlens arrays 12 and 13 may be integrally formed. The shape of microlens arrays 12 and 13 may match the shape of the irradiated surface and may be square, rectangular or circular. The size of microlens arrays 12 and 13 may be the size to be incident all the light source image formed by a laser light emitted from a plurality of LDs 11.

Dichroic mirror 15, for example, has a characteristic of passing through a wavelength light longer than a predetermined wavelength, and reflecting a wavelength light shorter than the predetermined wavelength. In the specification, it is assumed that dichroic mirror 15 reflects the laser light (excitation light) emitted from LD 11 and passes through the light emitted by the phosphor on phosphor wheel 14. Light (excitation light) which is incident on dichroic mirror 15 is reflected in the direction of phosphor wheel 14, is condensed by lens 1e, and is irradiated to the phosphor on phosphor wheel 14.

Phosphor wheel 14 emits light (e.g., yellow light) having wavelengths different from those of the excitation light (e.g., blue light) from the excitation light (e.g., blue light) emitted from LD 11. Phosphor wheel 14, by rotating at a high speed by a motor (not shown), reduces the temperature rise of the phosphor by moving the irradiated position of the excitation light, and efficiently cools the phosphor. The light emitted by the phosphor passes through the lens 1e, and is incident on dichroic mirror 15, and passes through dichroic mirror 15.

In the first exemplary embodiment, since white light is emitted from the light source device, color light which is insufficient for the synthesis of white light and which is different from the color light emitted by the phosphor is generated by color synthesis system 16. For example, when yellow light is emitted by a phosphor, blue light may be emitted by color synthesis system 16. In this case, color synthesis system 16 may be configured to include a blue LD, a diffusion plate for diffusing the laser light emitted from the blue LD, a lens or the like for irradiating dichroic mirror 15 by condensing the light emitted from the diffusion plate. If it is provided with a configuration for making uniform the intensity distribution of light emitted from the light source device to the illumination projection optical system 17 to be described later, the diffusion plate may not be used. The color light used for the synthesis of the white light may be the same color light as the laser light emitted from LD 11, and the laser light emitted from LD 11 may be used for the synthesis of the white light.

Light emitted from color synthesis system 16 is reflected by dichroic mirror 15 and is synthesized with light that is passed through dichroic mirror 15 and that is emitted by the phosphor, and the synthesize light is output from the light source device.

Light (white light) emitted from the light source device is optical modulated for each of the three primary colors of red, green and blue light according to the video signal, and is incident on the illumination projection optical system 17 that projects the image lights formed by the optical modulation.

As shown in FIG. 2, the illumination projection optical system 17 includes illumination optical system 2, optical modulating unit 3, and projection optical system 4. FIG. 2 shows a configuration example of an illumination projection optical system 17 using a liquid crystal panel as an image forming device included in optical modulating unit 3. The present invention is also applicable to a configuration in which the DMD is used as an image forming device.

Illumination optical system 2 includes integrator 2a, polarizing beam splitter 2b, lens 2c, first dichroic mirror 2d, second dichroic mirror 2e, first relay lens 2f, first mirror 2g, second relay lens 2h, third relay lens 2i, second mirror 2j, fourth relay lens 2k and third mirror 2m.

Integrator 2a converts the light emitted from the light source device into light having a uniform intensity distribution in the irradiated surface (liquid panel surface). For example, a pair of two fly-eye lenses may be used as integrator 2a. The fly-eye lens has a configuration in which a plurality of microlenses (cells) are arranged in two directions orthogonal to each other, and is similar to microlens arrays 12 and 13.

Polarizing beam splitter 2b uniforms polarization of light emitted from integrator 2a and outputs the light. Light output from polarizing beam splitter 2a is incident on first dichroic mirror 2d by lens 2c.

First dichroic mirror 2d, for example, passes through green light and blue light and reflects red light. Red light reflected by first dichroic mirror 2d is incident on first mirror 2g by first relay lens 2f, and is incident on optical modulating unit 3 by reflecting first mirror 2g. Green light and blue light passed through first dichroic mirror 2d are incident on second dichroic mirror 2e by second relay lens 2h.

Second dichroic mirror 2e, for example, passes through blue light and reflects green light. Green light reflected by second dichroic mirror 2e is incident on optical modulating unit 3. Blue light passed through second dichroic mirror 2e is incident on second mirror 2j by third relay lens 2i.

Second mirror 2j reflects the blue light which is incident, the reflected blue light is incident on third mirror 2m by fourth relay lens 2k. Third mirror 2m is incident on optical modulating unit 3 by reflecting the blue light which is incident.

Optical modulating unit 3 includes liquid crystal panel 3a which is an image forming device, polarizing plate 3b and cross prism 3c.

Each color light separated by illumination optical system 2 is incident through polarizing plate 3b to liquid crystal panel 3a prepared for each R (red)/G (green)/B (blue), respectively and is optical modulated based on the video signal. Each color light (image light) formed by being optical modulated is synthesized by cross prism 3c, and is projected as an image on a screen or the like (not shown) through projection optical system 4 having projection lens 4a.

In such a configuration, the present invention uniforms intensity distribution of light on a specific irradiated surface by arranging the light source and the microlens array so that the long axis direction of the light source image formed by the laser light on the irradiated surface of the microlens array intersects with the direction in which the cells are aligned.

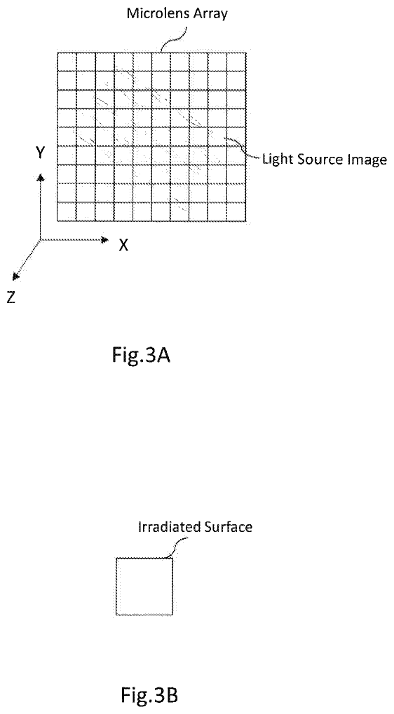

For example, a coordinate system is set which includes: a first axis parallel to a principal ray of laser light incident on the microlens array; a second axis, in the direction in which the laser light emitted from the microlens array or the fluorescence emitted from the phosphor is reflected, in a direction orthogonal to the first axis; and a third axis orthogonal to the first axis and the second axis, respectively. In the example shown in FIG. 3A, for example, the first axis is the Z axis, the second axis is the X axis, and the third axis is the Y axis. Then, in the first exemplary embodiment, the microlens array are arranged so that the two directions in which the cells are aligned are parallel to the direction of the second axis and the direction of the third axis.

Hereinafter, the direction in which the cells are arranged may be referred to as a “direction of boundary line of a cell”. In the following, the present specification will be described in an example in which the LD and the microlens array are arranged so that the long axis direction of the light source image and the boundary lines or the diagonal lines of the cells are intersected. The LD and the microlens array may be arranged so that the short axis direction of the light source image and the boundary lines or the diagonal lines of the cells are intersected.

As shown in FIG. 1, when the intensity distribution of the excitation light irradiated to the phosphor is uniformed, microlens arrays 12 and 13 are arranged so that the boundary lines of the plurality of cells are along the X-axis shown in FIG. 3A. Then, each of LD 11 is placed so that the direction of the boundary lines of the cells of microlens array 12 and 13 and the long axis direction of the light source image are intersected.

On the other hand, as shown in FIG. 2, when the intensity distribution of the illumination light irradiated to the liquid crystal panel 3a (image forming device) is uniformed, a microlens array (integrator 2a) is arranged so that the boundary lines of the plurality of cells are along the X-axis shown in FIG. 3A to arrange. Then, each LD which is included in color synthesis system 16 is arranged so that the direction of the boundary lines of the cells of the microlens array (integrator 2a) and the long axis direction of the light source image are intersected.

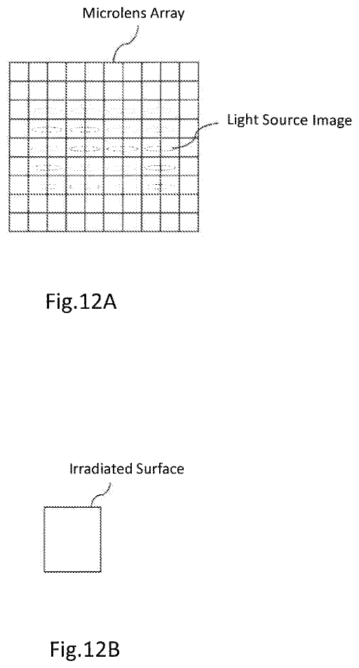

As shown in FIG. 12A, when the direction of the boundaries of the cells and the long and short axis directions of the light source images which are incident on the microlens array are parallel, the light from the light source is relatively uniformly which is incident on each cell. In that case, since the light having the same intensity distribution from each cell is output, in the irradiated surface (imaging surface), caused by the elliptical light source image, the light having the non-uniformity intensity distribution emitted from each cell is superimposed. Consequently, bias occurs in the intensity distribution of light in the irradiated surface as shown in FIG. 12B.

On the other hand, as shown in FIG. 3A, when the direction of the boundary lines of the cells, and the long axis direction and the short axis direction of the light source image are intersected, the light from the light source is never uniformly incident on a plurality of adjacent cells. In such cases, since light having different intensity distributions is emitted from the respective cells, the light intensity distributions on the irradiated surface become uniform as shown in FIG. 3B by superimposing the light intensity distributions on the irradiated surface.

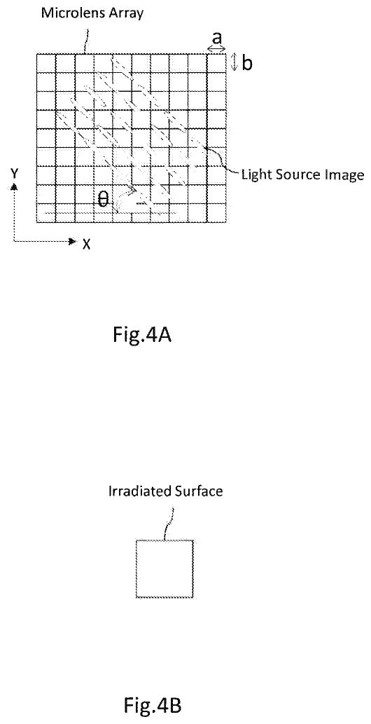

As shown in FIG. 4A, even if the long axis direction and the short axis direction of the light source image incident on the diagonal direction and the microlens array of each cell are parallel, the light source light is uniformly incident on each cell. As a result, the uniformity of the light intensity distribution on the irradiated surface decreases as shown in FIG. 4B. Therefore, it is desirable that each LD is arranged so that the long axis direction of the light source image intersects with not only the direction of the boundary lines of the cells, also with respect to the direction of the diagonal lines of the cells.

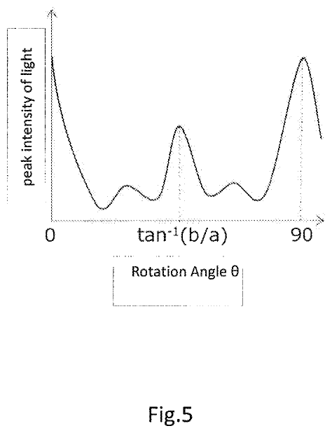

As shown in FIG. 4A, in a plane consisting of X-axis and Y-axis which are parallel to the boundary lines of the cells and which are orthogonal lines to each other, it is assumed that the length of the X-axis direction of each cell is a and the length of the Y-axis direction is b. The peak intensity of light in the irradiated surface with respect to the rotation angle of the light source image (the angle in the long axis direction with respect to the X-axis) θ will be shown in FIG. 5. It is assumed that a plurality of cells included in the microlens array is arranged in a lattice pattern.

As shown in FIG. 5, when the rotational angle θ of the light source image is 0 degrees, 90 degrees and tan⁻¹(b/a), light having local peaks in the intensity distributions is irradiated to the irradiated surface. The rotation angle θ of the light source image is 0 degrees and 90 degrees, when the direction of the long axis direction and the boundary lines of the cells of the light source image are parallel. The rotational angle θ in which the light source image is tan⁻¹(b/a) is a case when the long axis direction of the light source image and the direction of the diagonal lines of the cells are parallel.

Therefore, in order to make the intensity distribution of the light on the irradiated surface makes uniform, the rotational angle θ of the light source image is not set to 0 degrees, 90 degrees, tan⁻¹(b/a), and angles around them.

Specifically, it is desirable that the angle at which the long axis direction of the light source image for each LD and the direction of the boundary lines of the cells are intersected is 5 degrees or more. Similarly, it is desirable that the angle at which the long axis direction of the light source image for each LD and the direction of the diagonal lines of the cells are intersected is 5 degrees or more.

That is, the rotation angle θ of the long axis direction of the light source image with respect to the X-axis is desirable as follows:

5 degrees≤θ≤tan⁻¹(b/a)−5 degrees, or

tan⁻¹(b/a)+5 degrees≤θθ85 degrees. [Equation 1]

For example, if each cell is square, the rotation angle θ in the long axis direction of the light source image with respect to the X-axis may be set in a range of 5 to 40 degrees or 50 to 85 degrees. When setting the rotation angle of the short axis direction of the light source image with respect to the X-axis, since the short axis direction of the light source image is a direction orthogonal to the long axis direction, it may be used an angle obtained by adding 90 degrees to the rotation angle θ of the long axis direction.

If the cell is sufficiently large with respect to the size of the light source image on the irradiated surface of the microlens array, the probability that the light source image is incident across a plurality of adjacent cells to the microlens array is reduced. In that case, the light flux of the light source image to be incident on the microlens array is difficult to be divided by a plurality of cells, even if the long axis direction of the light source image and the direction of the boundary lines or the direction of the diagonal lines of the cells are intersected, there is a possibility that the uniform light intensity distribution in the irradiated surface cannot be obtained. Therefore, the size of the cells of the microlens array, it is desirable that the light source image on the irradiated surface of the microlens array is sized so as to be incident across a plurality of cells.

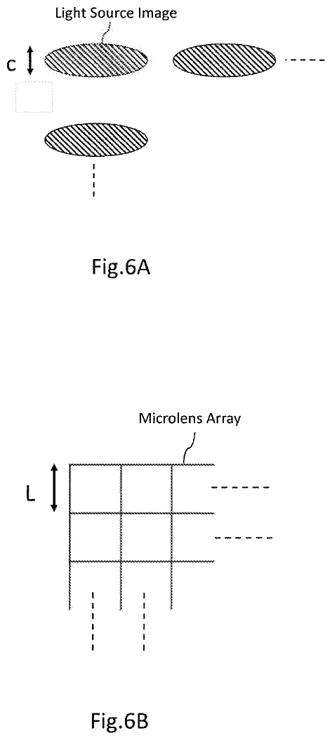

For example, as shown in FIG. 6A, consider an example in which it is assumed that the width of the short axis direction of the light source image incident on the microlens array is c, and in which, as shown in FIG. 6B, the length of the cell parallel to the short axis direction of the light source image is L.

If L≤0.5c, since the cell with respect to the size of the light source image can be said to be sufficiently small, the direction of the boundary lines or the direction of the diagonal lines of the cells and the long axis direction of the light source image are not intersected, the intensity distribution of the light in the irradiated surface becomes relatively uniform. Therefore, in the case of L≤0.5c, it may not necessary that the direction of the boundary lines or the direction of the diagonal lines of the cells and the long axis direction of the light source image are intersected. Of course, even L≤0.5c, the direction of the boundary lines or the direction of the diagonal lines of the cells and the long axis direction of the light source image may be intersected. However, as described above, in the microlens array having small cells, since the edge sag easily occurs at the time of manufacturing, it is desirable that the length of L is 0.5c or more.

On the other hand, in the case of L≤3.0c, since the cell can be said to be sufficiently large with respect to the size of the light source image, even if the direction of the boundary lines or the direction of the diagonal lines of the cells and the long axis direction of the light source image are intersected, there is a possibility that the intensity distribution of light in the irradiated surface is not uniform.

Therefore, the optical system including the LD and the microlens array to which the first exemplary embodiment is applied may be designed such that L≤3.0c, and in particular, it is desirable to design such that 0.5c<L≤3.0c.

In the above description, an example of a configuration in which a plurality of LDs is used as light sources has been described, but the number of LDs may be one. If a plurality of LDs is used as a light source, since the light source image is incident divided in various patterns for each cell of the microlens array, the effect of the present invention is more easily obtained.

According to the first exemplary embodiment, each LD and the microlens array is arranged so that the direction of the boundary lines or the direction of the diagonal lines of the cells and the long axis direction of the light source image are intersected. Thus, lights having different intensity distributions are emitted from each cell, and the lights are superimposed on the irradiated surface, so that the intensity distribution of the light on the irradiated surface becomes uniform.

Therefore, the non-uniformity of the light intensity distribution caused by the shape of the light source image in a particular irradiated surface can be improved.

### Second Exemplary Embodiment

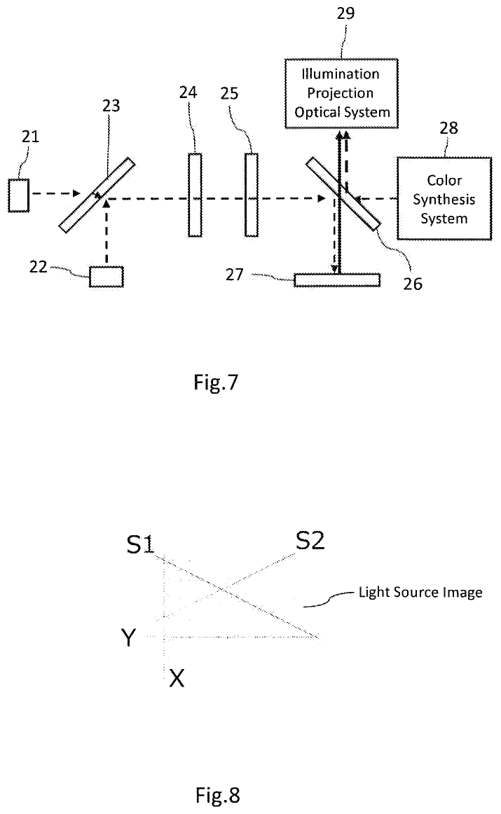

FIG. 7 is a schematic diagram showing another configuration example of a light source device included in a projector, FIG. 8 is a schematic diagram showing an arrangement example of the light source image obtained by the light source device shown in FIG. 7. FIG. 7 shows only a simplified main configuration of the light source device of the second exemplary embodiment, it may be provided an optical component such as a lens or a mirror if necessary.

The light source device of the second exemplary embodiment is a configuration example in which laser lights emitted from two synthetic light source units are synthesized to obtain brighter projection light, and the synthesized light is used as excitation light for irradiating the phosphor with the synthesized light. FIG. 7 shows an example in which light emitted by two synthetic light source units is synthesized, but light emitted by three or more synthetic light source units may be synthesized.

The light source device of the second exemplary embodiment shown in FIG. 7 includes two synthetic light source units 21 and 22, synthetic mirror 23, microlens arrays 24 and 25, dichroic mirror 26, phosphor 27 and color synthesis system 28.

Synthetic light source units 21 and 22 are configured to each comprise a plurality of light sources, for example, a plurality of LDs is arranged in a lattice pattern.

Synthetic mirror 23 has a property of passing through light incident on one surface and of reflecting light incident on the other surface. Lights emitted from synthetic light source units 21 and 22 are respectively incident on synthetic mirror 23, and is synthesized by synthetic mirror 23, the synthesized light is incident on microlens arrays 24 and 25.

As described above, microlens arrays 24 and 25 convert the light incident into a uniform light intensity distribution to incident on dichroic mirror 26.

Dichroic mirror 26 has a characteristic of reflecting the light emitted from synthetic light source units 21 and 22 (excitation light) and of passing through light emitted by phosphor 27. Light incident on dichroic mirror 26 is reflected and is irradiated onto phosphor 27.

Phosphor 27 is configured to be fixed to a predetermined portion having no rotation mechanism or movement mechanism, and emits light (e.g., yellow light) having a wavelength different from that of the excitation light from the excitation light (e.g., blue light) emitted from synthetic light source units 21 and 22. The light emitted by phosphor 27 is incident on dichroic mirror 26 and passes through dichroic mirror 26.

In the second exemplary embodiment, since white light is emitted from the light source device similarly to the first exemplary embodiment, color light different from the color light emitted by phosphor 27, which is insufficient for the synthesis of white light, is generated by color synthesis system 28. For example, when yellow light is emitted by phosphor 27, color synthesis system 28 may emit blue light. Color synthesis system 28 may have the same configuration as that of the first exemplary embodiment.

The output light of color synthetic system 28 is reflected by dichroic mirror 26, is incident on illumination projection optical system 29 to synthesize with the light, which is passed through dichroic mirror 26, emitted by phosphor 27.

In such a configuration, in the second exemplary embodiment, as described above, the laser light s emitted from two synthetic light source units 21 and 22 are synthesized by synthesizing mirror 23. At this time, the respective light source images after synthesis formed by a plurality of laser lights can also be arranged in a lattice pattern as shown in FIG. 3A, but is arranged in a staggered manner as shown in FIG. 8.

When a plurality of light source images is arranged in a staggered manner, in addition to the short axis direction of each light source image shown by X and the long axis direction of each light source image shown by Y in FIG. 8, each light source image is also arranged periodically to the first and the second directions, which are different from the long axis direction and the short axis direction, in which a plurality of light source images shown by S1 and S2 are linearly arranged.

Therefore, when a plurality of light source images is arranged in a staggered manner, each LD and microrange array is arranged so that the direction of the boundary lines of the cells intersects with the short axis direction of each light source image, the long axis direction of each light source image, and the first and second directions, respectively. Also, each LD and microrange array are arranged so that the direction of the diagonal lines of the cells intersects with the short axis direction of each light source image, the long axis direction of each light source image, and the first and second directions, respectively.

At this time, it is desirable that the angle at which the direction of the boundary lines of the cells intersects with the short axis direction of each light source image, the long axis direction of each light source image, and the first and second directions is 5 degrees or more, similarly to the first exemplary embodiment. Also, it is desirable that the angle at which the direction of the diagonal lines of the cells intersects with the short axis direction of each light source image, the long axis direction of each light source image, and the first and second directions is 5 degrees or more, similarly to the first exemplary embodiment.

When the light emitted by the three or more synthetic light source units are synthesized, each LD and microrange array is arranged so that the direction of the boundary lines or the direction of the diagonal lines of the cells intersects with the short axis direction of each light source image, the long axis direction of each light source image, as well as the directions in which a plurality of light source images of the others are linearly arranged.

According to the second exemplary embodiment, when the light source images are arranged in a staggered manner on the irradiated surface of the microlens array, each LD and microrange array are arranged so that the direction of the boundary lines or the direction of the diagonal lines of the cells intersects with the short axis direction of each light source image, the long axis direction of each light source image, as well as the directions in which a plurality of light source images of others are linearly arranged. In this case, similarly to the first exemplary embodiment, light having a uniform intensity distribution is irradiated onto a predetermined irradiated surface. Therefore, the non-uniformity of the light intensity distribution caused by the shape of the light source image in a particular irradiated surface can be improved.

### Third Exemplary Embodiment

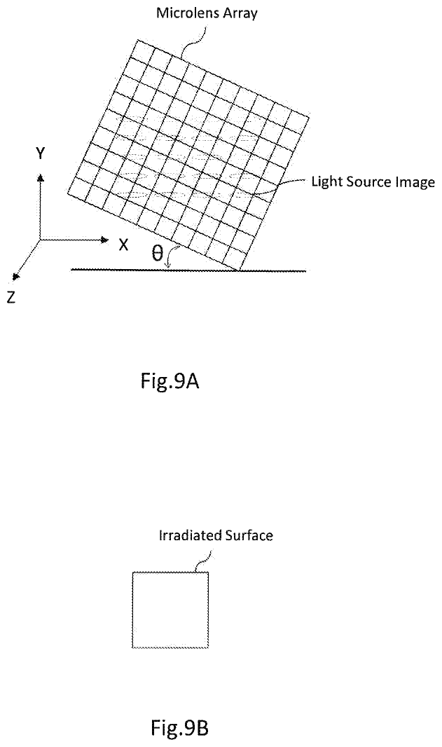

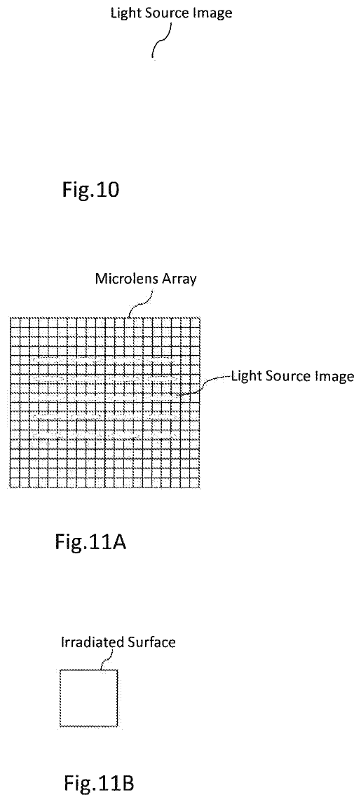

FIG. 9A is a schematic diagram showing an example of a relationship between the light source image and the microlens array of the third exemplary embodiment, FIG. 9B is a schematic diagram showing an example of light intensity distribution of the irradiated surface in a relationship example between the light source image and the microlens array shown in FIG. 9A.

As mentioned above, the first and second exemplary embodiments shown the examples in which the microlens array are arranged so that two directions of the cells which are aligned are parallel to the direction of the second axis and the direction of the third axis, and in which each LD is arranged so that the direction of the boundary lines and the diagonal lines of the cells and the long axis direction of the light source image are intersected.

The third exemplary embodiment, for example, is an example in which a light source is arranged so that the long axis direction of the light source image is along the X-axis, and in which the microlens array is arranged so that the direction of the boundary lines and diagonal lines of the cells and the long axis direction of the light source image are intersected.

In the third exemplary embodiment, similarly to the first exemplary embodiment, a coordinate system is set which includes X-axis (first axis) and Y-axis (second axis) orthogonal to each other, and Z-axis (third axis) orthogonal to the X-axis and the Y-axis, respectively (see FIG. 9A). Then, in the third exemplary embodiment, the microlens array is arranged so that the two directions in which the cells are aligned and the directions of the second axis and the third axis are intersected.

For example, as shown in FIG. 1, when the intensity distribution of the excitation light irradiated to the phosphor is uniform, each LD 11 is arranged so that the long axis direction of the light source image on the irradiated surface of the microlens array is along the X-axis shown in FIG. 9A. Then, the microlens arrays 12 and 13 are arranged so that the long axis direction of the light source image of each LD 11 and the direction of the boundary lines of the cells are intersected. Also, the microlens arrays 12 and 13 are arranged so that the long axis direction of the light source image of each LD 11 and the direction of the diagonal lines of the cells are intersected.

As shown in FIG. 2, when the intensity distribution of the illumination light irradiated on liquid crystal panel 3a (image forming device) is uniform, a plurality of LDs included in color synthesis system 16 is arranged so that the long axis direction of the light source image on the irradiated surface of the microlens array is along the X-axis shown in FIG. 9A. Then, the microlens array is arranged so that the long axis direction of the light source images of the plurality of LDs included in color synthesis system 16 intersects with the direction of the boundary lines of the cells of the microlens array used as the integrator 2a. Also, the microlens array is arranged so that the long axis direction of the light source images of the plurality of LDs included in color synthesis system 16 intersects with the diagonal direction of the cells of the microlens array used as the integrator 2a.

At this time, in order to make uniform the intensity distribution of light in the irradiated surface, similarly to the first exemplary embodiment, it is desirable that the angle at which the direction of the long axis of the light source image and the direction of boundary lines of the cells are intersected is 5 degrees or more. Also, it is desirable that the angle at which the direction of the long axis of the light source image and the direction of diagonal lines of the cells are intersected is 5 degrees or more.

Furthermore, when a plurality of light source images is arranged in a staggered manner, similarly to the second exemplary embodiment, each LD and the micro-range array are arranged so that the direction of the boundary lines of the cells intersects with the short axis direction of each light source image, the long axis direction of each light source image, as well as a direction in which a plurality of light source images of others are linearly arranged, respectively. Also, each LD and the micro-range array are arranged so that the direction of the diagonal lines of the cells intersects with the short axis direction of each light source image, the long axis direction of each light source image, as well as the directions in which a plurality of light source images of others are linearly arranged, respectively.

At this time, it is desirable that the angle at which the direction of the boundary lines of the cells intersects with the short axis direction of each light source image, the long axis direction of each light source image, as well as a direction in which a plurality of light source images of others is linearly arranged, as in the first exemplary embodiment, is 5 degrees or more. Also, it is desirable that the angle at which the direction of the diagonal lines of the cells intersects with the short axis direction of each light source image, the long axis direction of each light source image, as well as the directions in which a plurality of light source images of others is linearly arranged is 5 degrees or more.

Thus, even if the microlens array is arranged so that the direction of the boundary lines or the direction of the diagonal lines of the cells intersects with the long axis direction of each light source image, the short axis direction of each light source image, as well as a direction in which a plurality of light source images of others is linearly arranged, similarly to the first and second exemplary embodiments, light having a uniform intensity distribution is irradiated onto a predetermined irradiated surface (see FIG. 9B). The configuration of the other light source devices and the relationship between the microlens array and the LD are the same as those in the first and second exemplary embodiments, and therefore, the description thereof is omitted.

According to the third exemplary embodiment, similarly to the first and second exemplary embodiments, the non-uniformity of the light intensity distribution caused by the shape of the light source image in a particular irradiated surface can be improved.

Although the present invention has been described above with reference to the exemplary embodiments, the present invention is not limited to the above-described exemplary embodiments. Various modifications that can be understood by those skilled in the art within the scope of the present invention are possible in the configuration and details of the present invention.

1. A light source device for generating laser light that is irradiated to a microlens array, comprising a plurality of microlenses arranged in two directions orthogonal to each other, comprising:
a plurality of light sources that emits laser light, wherein:
a light source image of a light source on an irradiated surface of the microlens array is elliptical; and
a long axis direction of the light source image intersects with both the two directions.

2. The light source device according to claim 1, wherein the microlens array comprises a configuration in which the plurality of the microlenses is arranged in a lattice pattern.

3. The light source device according to claim 1, wherein the microlens has a rectangular shape, the long axis direction of the light source image and a direction of the diagonal lines of the microlens are intersected.

4. The light source device according to claim 3, wherein an angle at which the long axis direction of the light source image and the direction of the diagonal lines of the microlens are intersected is 5 degrees or more.

5. The light source device according to claim 1, wherein an angle at which the long axis direction of the light source image intersects with a direction in which the microlenses are arranged is 5 degrees or more.

6. The light source device according to claim 1, wherein a plurality of the light source images on the irradiated surface of the microlens array are arranged in a lattice pattern.

7. The light source device according to claim 1, wherein:
a plurality of the light source images on the irradiated surface of the microlens array are arranged in a staggered manner; and
a direction, which is different from the long axis direction and the short axis direction of the light source images, in which a plurality of the light source images is linearly arranged and a direction in which the microlenses are arranged are intersected.

8. The light source device according to claim 1, wherein when a width of a short axis direction of the light source image is c, and a length of a microlens parallel to the short axis direction of the light source image is L,
L≤3.0c.

9. The light source device according to claim 1, wherein when a width of a short axis direction of the light source image is c, and the length of a microlens parallel to the short axis direction of the light source image is L,
0.5c<L≤3.0c.

10. The light source device according to claim 1, wherein,
in a coordinate system comprising: a first axis that is parallel to a principal ray of the laser light incident on the microlens array; a second axis that is a direction orthogonal to the first axis, in a direction in which the laser light emitted from the microlens array or a fluorescence emitted from a phosphor is reflected; and a third axis that is orthogonal to the first axis and the second axis,
the two directions are parallel to the direction of the second axis or a direction of the third axis, respectively.

11. The light source device according to claim 1, wherein,
in a coordinate system comprising: a first axis that is parallel to a principal ray of the laser light incident on the microlens array; a second axis that is a direction orthogonal to the first axis, in a direction in which the laser light emitted from the microlens array or a fluorescence emitted from a phosphor is reflected; and a third axis that is orthogonal to the first axis and the second axis,
the two directions intersect with both the direction of the second axis and a direction of the third axis, respectively.

12. A projector comprising:
the light source device according to claim 1;
an optical modulating unit that forms an image light by optical modulating the light emitted from the light source device according to a video signal; and
a projection optical system that projects an image light formed by the optical modulating unit.

13. A light intensity distribution uniformization method for uniformizing an intensity distribution of light that is irradiated to a specific irradiated surface from a light source device that comprises a plurality of microlenses arranged in two directions orthogonal to each other, for generating laser light that is irradiated to a microlens array,
wherein the light source device comprises a plurality of light sources that emits laser light;
wherein a light source image of the light source on the irradiated surface of the microlens array is elliptical, the light intensity distribution uniformization method comprising:
arranging the light source so that a long axis direction of the light source image intersects with both the two directions; and
irradiating the specific irradiated surface with the light emitted from the microlens array.
